(19) United States
(12) Patent Application Publication
(10) Pub. No.: US 2011/0170910 A1
(43) Pub. Date: Jul. 14, 2011

(54) DEVELOPING DEVICE AND IMAGE FORMING APPARATUS INCLUDING THE SAME

(76) Inventors: Shigeki HAYASHI, Osaka (JP); Takafumi Nagai, Osaka (JP)

(21) Appl. No.: 13/004,378

(22) Filed: Jan. 11, 2011

(30) Foreign Application Priority Data
Jan. 12, 2010 (JP) 2010-004016

(51) Int. Cl. G03G 15/08

(52) U.S. Cl. 399/254

(57) ABSTRACT

A developing device to be installed in an electrophotographic image forming apparatus including a photoconductor drum that is to have an electrostatic latent image formed on a surface thereof, the developing device comprising: a developer vessel that accommodates a developer containing a toner and a carrier; a toner supply port; a developing roller; a developer conveying passage that is disposed between a position in the developer vessel where the toner is supplied and the developing roller; a developer conveying helical member that is rotatably disposed in the developer conveying passage to convey the developer in the developer conveying passage to the developing roller while agitating the developer; and an agitating blade member that is rotatably disposed above, near and along the developer conveying helical member in the developer conveying passage to agitate the developer on the developer conveying helical member.

### CROSS-REFERENCE TO RELATED APPLICATION

This application is related to Japanese patent application No. 2010-004016 filed on Jan. 12, 2010 whose priority is claimed under 35 USC §119, the disclosure of which is incorporated by reference in its entirety.

### BACKGROUND OF THE INVENTION

1. Field of the Invention

The present invention relates to a developing device and an image forming apparatus including the same.

2. Description of the Related Art

In recent years, for electrophotographic image forming apparatuses supporting full-color and high-quality images, a dual-component developer (hereinafter simply referred to as the “developer”) which exhibits an excellent charge performance stability as to a toner is in widespread use.

The developer is made up of the toner and a carrier, which are agitated in a developing device and frictionally rubbed with each other to produce an appropriately electrified toner.

In the developing device, the electrified toner is supplied onto a surface of a developing roller. The toner is moved by an electrostatic attraction from the developing roller to an electrostatic latent image formed on a surface of a photoconductor drum.

Thus, a toner image based on the electrostatic latent image is formed on the photoconductor drum.

Further, there has been an increasing demand for the image forming apparatuses that operate faster and that are miniaturized, which is associated with the necessity to electrify the developer quickly and sufficiently and to convey the developer quickly.

To this end, Prior Art 1 proposes a circulative developing device, which is intended to instantly disperse a toner supplied into the developing device (which may be referred to as the “supplied toner” hereinafter) into a developer in the developing device (which may be referred to as the “existing developer” hereinafter) and to provide the supplied toner with an appropriate amount of charge (for example, see Japanese Unexamined Patent Publication No. 10-63081).

The circulative developing device includes a developer conveying passage being a route along which the developer is conveyed in a circulative manner, and an auger screw that conveys the developer while agitating it inside the developer conveying passage.

With the image forming apparatus including the circulative developing device, when a toner concentration of the existing developer inside the developing device becomes lower than a prescribed value, the toner is supplied from a toner hopper in the image forming apparatus into the developer conveying passage in the developing device.

In this case, because a specific gravity of the toner is about one-third as small as that of the carrier, the supplied toner is prone to float on the existing developer. In addition, because it is difficult for the auger screw to circumferentially agitate the supplied toner whose specific gravity is small, the supplied toner is not easily blended into the existing developer.

Thus, because the electrification of the supplied toner in the existing developer is not easy, it is likely that the supplied toner with insufficient electrification and the existing developer being separated from each other are conveyed to the developing roller, and the supplied toner with a small amount of charge is supplied to the developing roller, causing the toner to scatter around or incurring formation of a foggy image.

To cope with the problem of Prior Art 1, Prior Art 2 proposes provision of a paddle member between helical blades of the auger screw for forcibly circumferentially agitating the developer (for example, see Japanese Unexamined Patent Publication No. 2006-337817).

However, with the structure of Prior Art 2, in a space where an axial extrusion force exerted from the helical blade of the auger screw to the developer and a circumferential extrusion force exerted from the paddle member to the developer are focused on an interior wall of a developer vessel (around an intersection of vectors), the developer tends to degrade.

That is, the developer confined by the helical blade of the auger screw, the paddle member, and the interior wall of the developer vessel is subjected to a stress due to a friction in such a pressurized state, and hence is prone to degrade. Thus, there is a problem that an enhancement of the circumferential agitation force promotes the degradation of the developer.

### SUMMARY OF THE INVENTION

The present invention has been made in consideration of the problem described in the foregoing, and an object thereof is to provide a developing device with which a supplied toner can be dispersed uniformly in a developer without putting an excessive stress on the developer, and an image forming apparatus including the same.

In order to achieve the above object, the present invention provides a developing device to be installed in an electrophotographic image forming apparatus including a photoconductor drum that is to have an electrostatic latent image formed on a surface thereof, the developing device including: a developer vessel that accommodates a developer containing a toner and a carrier; a toner supply port for supplying the toner into the developer vessel; a developing roller that is disposed in the developer vessel and that rotates while carrying the developer to supply the toner onto the surface of the photoconductor drum having the electrostatic latent image formed thereon; a developer conveying passage that is disposed between a position in the developer vessel where the toner is supplied and the developing roller; a developer conveying helical member that is rotatably disposed in the developer conveying passage to convey the developer in the developer conveying passage to the developing roller while agitating the developer; and an agitating blade member that is rotatably disposed above , near and along the developer conveying helical member in the developer conveying passage to agitate the developer on the developer conveying helical member.

Further, according to another aspect of the present invention, there is provided an image forming apparatus including: a photoconductor drum that is to have an electrostatic latent image formed on a surface thereof; a charging device that electrifies the surface of the photoconductor drum; an exposure device that forms the electrostatic latent image on the surface of the photoconductor drum; the developing device which supplies a toner to the electrostatic latent image on the surface of the photoconductor drum to form a toner image; a toner supplying device that supplies the toner to the developing device; a transferring device that transfers the toner image on the surface of the photoconductor drum to a recording medium; and a fusing device that fuses the toner image on the recording medium.

With the developing device of the present invention, the toner supplied onto the existing developer in the developer conveying passage is blended into the existing developer by the rotating agitating blade member, and the developer blended with the supplied toner is conveyed to the developing roller by the rotating developer conveying helical member.

In this case, because the agitating blade member rotates on the developer conveying helical member to agitate the supplied toner and the existing developer, the supplied toner is surely blended into the existing developer and sufficiently electrified.

Further, because the agitating blade member does not agitate the developer at a level lower than the developer conveying helical member, the developer will not suffer from the friction as being pressurized against an interior wall of the developer vessel. Hence, it is free of the problem of the developer being prone to degrade under the stress, which is observed in Prior Art 2.

Accordingly, with the image forming apparatus including the developing device, it becomes possible to reduce the toner scattering or the foggy image which would otherwise occur when a toner image is formed on a recording sheet due to an insufficiently electrified toner, and an excellent image can be obtained.

### BRIEF DESCRIPTION OF THE DRAWINGS

FIG. 1 is an explanatory illustration showing an overall structure of an image forming apparatus including a developing device according to a first embodiment of the present invention;

FIG. 2 is a schematic enlarged cross-sectional view of the developing device shown in FIG. 1;

FIG. 3 is a cross-sectional view taken along a line A-A in FIG. 2;

FIG. 4 is a cross-sectional view taken along a line B-B in FIG. 2;

FIG. 5 is a front view of an agitating blade member of the developing device according to the first embodiment.

FIG. 6 is a schematic cross-sectional view of a toner supplying device of the developing device according to the first embodiment;

FIG. 7 is a cross-sectional view taken along line a C-C in FIG. 6;

FIG. 8 is a cross-sectional view describing a first agitation state of a developer caused by the agitating blade member when the developing device according to the first embodiment is in operation;

FIG. 9 is a cross-sectional view describing an agitation state subsequent to FIG. 8;

FIG. 10 is a cross-sectional view describing an agitation state subsequent to FIG. 9; and

FIG. 11 is a front view showing an agitating blade member of a developing device according to a second embodiment of the present invention.

### DETAILED DESCRIPTION OF THE PREFERRED EMBODIMENTS

As described above, the developing device of the present invention includes the developer vessel, the toner supply port, the developing roller, the developer conveying passage, the developer conveying helical member, and the agitating blade member, and is installed in the electrophotographic image forming apparatus such as a monochrome or full-color copier, printer, facsimile machine, or multi function peripheral possessing the functions of the foregoing apparatuses.

The developing device may be structured employing the following modes, which can be used in any combination.

(1) the developer conveying passage includes: a first developer conveying passage associated with the toner supply port and a second developer conveying passage associated with the developing roller, the first developer conveying passage and the second developer conveying passage being defined by a partitioning plate extending in parallel to an axial direction of the developing roller; and a first communicating path and a second communicating path that establish a communication between the first developer conveying passage and the second developer conveying passage at opposite sides in the axial direction. The developer conveying helical member includes a first developer conveying helical member disposed in the first developer conveying passage and a second developer conveying helical member disposed in the second developer conveying passage. The agitating blade member is disposed above and near the first developer conveying helical member in the first developer conveying passage. The first developer conveying helical member and the second developer conveying helical member convey the developer in directions opposite to each other, such that the developer circulates through the first developer conveying passage and the second developer conveying passage.

Thus, it becomes possible to obtain a space-saving developer circulate mechanism that circulates the developer in the developer vessel, whereby a concentration of the toner in the developer can be maintained at a constant level.

(2) The first developer conveying helical member includes a first rotary shaft rotatably disposed in the first developer conveying passage and a helical blade fixed to the first rotary shaft. The agitating blade member includes a second rotary shaft rotatably disposed above, near and in parallel to the first rotary shaft in the first developer conveying passage, and an agitating blade fixed to the second rotary shaft.

Thus, it becomes possible to allow the agitating blade member to agitate the supplied toner in the rotational circumferential direction of the developer conveying helical member, so that the supplied toner is efficiently blended into the existing developer.

(3) The second rotary shaft is disposed right aboveright above the first rotary shaft.

Thus, it becomes possible to agitate and blend without unevenness the existing developer and the supplied toner on the first rotary shaft of the developer conveying member by use of one circumferentially agitating member.

It is to be noted that two agitating blade members may be provided to one developer conveying member. In such a case, preferably, two second rotary shafts are symmetrically disposed diagonally upward relative to one first rotary shaft, so as to agitate and blend without unevenness the existing developer and the supplied toner on the first rotary shaft, while avoiding interference between the agitating blade members.

(4) The developing device further includes a rotary mechanism that synchronously rotates the first rotary shaft and the second rotary shaft. The agitating blade is made up of a plurality of agitating plate portions radially disposed about the second rotary shaft. The agitating plate portions are formed so as to extend in an axial direction of the second rotary shaft. The agitating plate portions have a plurality of clearances or notches for avoiding any contact with the helical blade when the first and second rotary shafts are synchronously rotated.

Thus, the plurality of agitating plate portions can be rotated while avoiding any contact with the rotating helical blade. Accordingly, the agitating blade can be disposed near the first rotary shaft of the developer conveying member, such that the supplied toner at a level higher than the first rotary shaft and the existing developer can effectively be agitated in the rotational circumferential direction.

(5) The rotary mechanism rotates the first rotary shaft and the second rotary shaft at an identical rotation speed. An interval of the plurality of clearances or notches of the agitating plate portions is identical to a helical interval of the helical blade.

Thus, a width of each of the clearances or notches of the agitating plate portions can be minimized to increase an area in contact with the supplied toner. Accordingly, the supplied toner at the level higher than the first rotary shaft and the existing developer can more effectively be agitated in the rotational circumferential direction without unevenness.

(6) A central angle formed between two circumferentially adjacent ones of the agitating plate portions of the agitating blade is 90°.

Thus, every time the agitating blade rotates by 90°, the supplied toner on the first rotary shaft and the existing developer are circumferentially agitated by the agitating plate portions. In this case, because a great height difference is generated at the top layer of the developer, it becomes easier for the supplied toner whose specific gravity is smaller than that of the carrier to be blended into the existing developer.

In the following, with reference to the drawings, embodiments of a developing device of the present invention and an image forming apparatus including the same will be described in detail.

### <First Embodiment>

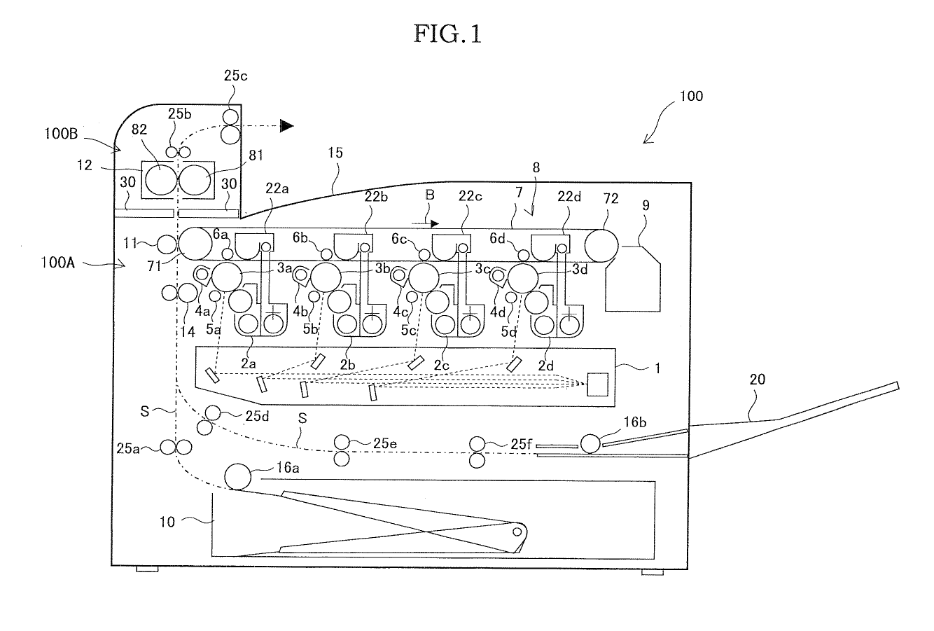

FIG. 1 is an explanatory illustration showing an overall structure of an image forming apparatus including a developing device according to a first embodiment of the present invention.

An image forming apparatus 100 is a printer capable of forming a multi-color or single-color image on a sheet-like recording medium (recording sheet) based on image data externally received, the image forming apparatus 100 including: a developing device housing 100A in which a plurality of developing devices 2a to 2d are each accommodated in a casing; a fusing device housing 100B in which a fusing device 12 is accommodated above the developing device housing 100A inside the casing; and a partition wall 30 disposed between the developing device housing 100A and the fusing device housing 100B for insulating the heat generated by the fusing device 12.

A top face of the developing device housing 100A positioned beside the fusing device housing 100B serves as a sheet exit tray 15.

In the present embodiment, the printer is shown as an example of the image forming apparatus. On the other hand, the image forming apparatus can be a copier, a facsimile machine or a multi function peripheral possessing functions of the foregoing apparatuses, that can form a multi-color or single-color image on a recording medium based on image data externally received and/or image data read from an original by use of a scanner.

### [Developing Device Housing]

As shown in FIG. 1, the developing device housing 100A chiefly accommodates: four photoconductor drums 3a, 3b, 3c, and 3d; four chargers (charging devices) 5a, 5b, 5c, and 5d that respectively electrify surfaces of the photoconductor drums 3a to 3d; an exposure unit (exposure device) 1 that forms an electrostatic latent image on each of the surfaces of the photoconductor drums 3a to 3d; four developing devices 2a, 2b, 2c, and 2d that accommodate corresponding ones of toners of black, cyan, magenta and yellow to develop the electrostatic latent images on the surfaces of corresponding ones of the photoconductor drums 3a to 3d to thereby form toner images; cleaner units 4a, 4b, 4c, and 4d that remove remaining toners on the surface of each of the photoconductor drums 3a to 3d after development and image transfer operations are carried out; four toner supplying devices 22a, 22b, 22c, and 22d that supply corresponding ones of the four-color toners to corresponding ones of the developing devices 2a to 2d; an intermediate transfer belt unit (transferring device) 8 that transfer the toner images on the surfaces of the photoconductor drums 3a to 3d to a recording medium; and an intermediate transfer belt cleaner unit 9.

The developing device housing 100A further includes: a sheet feeding tray 10 disposed at a bottommost position in the developing device housing 100A to store a plurality of recording media; a manual sheet feeding tray 20 disposed on one side of the developing device housing 100A such that a recording medium of an arbitrary size is set thereon; and a sheet conveying path S for conveying a recording medium from the sheet feeding tray 10 or the manual sheet feeding tray 20 to an intermediate transfer belt unit (transferring device) 8.

As used herein, as to members denoted by reference character associated with “a” to “d”, “a” refers to those members for forming a black image, “b” refers to those members for forming a cyan image, “c” refers to those members for forming a magenta image, and “d” refers to those members for forming a yellow image.

That is, the image forming apparatus 100 is structured such that, based on image data for each of black, cyan, magenta, and yellow color components, a black toner image, a cyan toner image, a magenta toner image and a yellow toner image are selectively formed on the surfaces of the photoconductor drums 3a to 3d, and the formed toner images are overlaid one over another on the intermediate transfer belt unit 8, so as to form a full-color image on the recording medium.

Because the photoconductor drums 3a to 3d corresponding to respective colors are of the same structure, the description thereof will collectively be given employing a unified reference character “3”. Similarly, the description will collectively be given employing a unified reference character “2” as to the developing devices; a unified reference character “5” as to the chargers; a unified reference character “4” as to the cleaner units; and a unified reference character “22” as to the toner supplying devices.

### (Photoconductor Drum and Peripheral Members Thereof)

The photoconductor drum 3 is structured with an electrically conductive base and a photosensitive layer formed on a surface of the base. The photoconductor drum 3 is a cylindrical member that forms a latent image by electrification and exposure. The photoconductor drum 3 exhibits electrical conduction as being illuminated by a light beam, whereby an electrical image called an electrostatic latent image is formed on the surface of the photoconductor drum 3.

The photoconductor drum 3 is supported by not-shown drive means such that it can rotate about its axis.

As the charger 5, a contact roller-type charger, a contact brush-type charger or a non-contact discharging type charger is used, to uniformly electrify the surface of the photoconductor drum 3 to a prescribed potential.

The exposure unit 1 allows a light beam corresponding to image data to pass between the charger 5 and the developing device 2, to illuminate the electrified surface of the photoconductor drum 3 to expose it thereby, such that an electrostatic latent image corresponding to the image data is formed on the surface of the photoconductor drum 3.

In the present embodiment, an exemplary case in which a laser scanning unit (LSU) provided with a laser emitter and reflection mirrors is shown as the exposure unit 1. On the other hand, arrays of light emitting elements such as EL (electroluminescence) or LED writing heads may also be used as the exposure unit 1.

### (Developing Device)

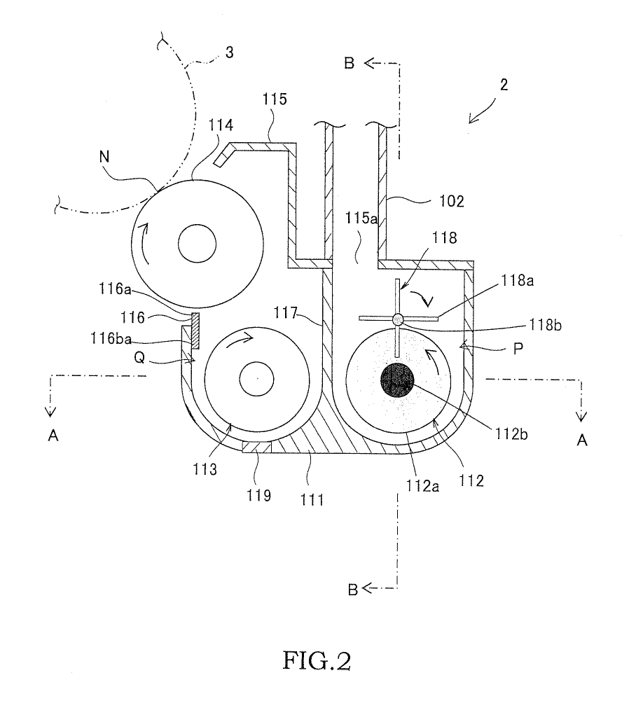

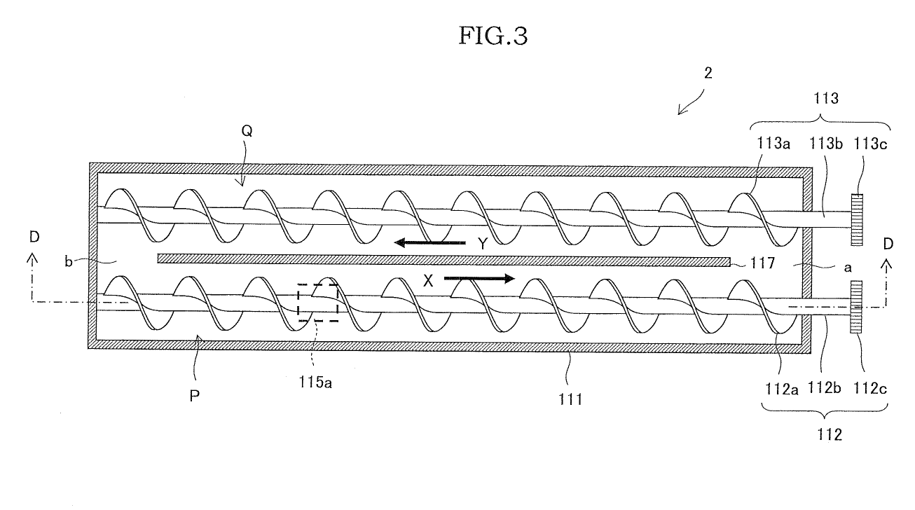

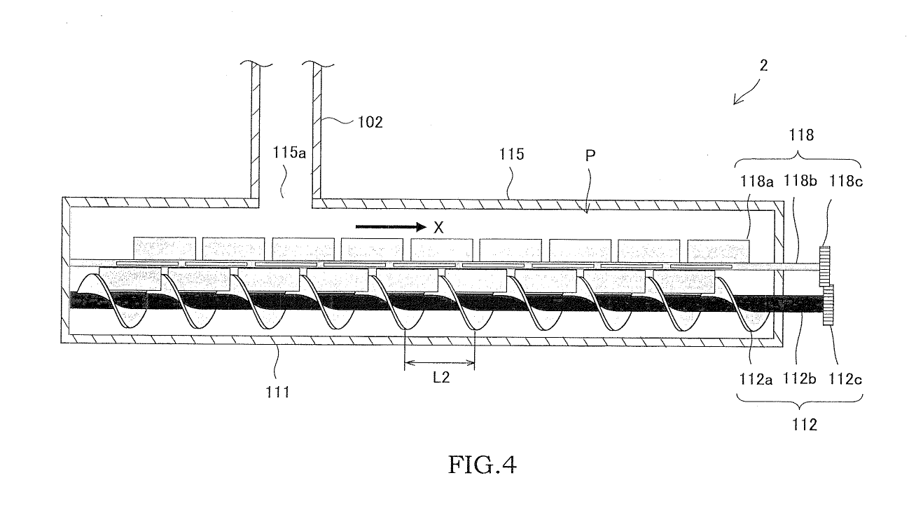

FIG. 2 is a schematic enlarged cross-sectional view of the developing device shown in FIG. 1. FIG. 3 is a cross-sectional view taken along a line A-A in FIG. 2. FIG. 4 is a cross-sectional view taken along a line B-B in FIG. 2.

As shown in FIGS. 2 to 4, the developing device 2 includes: a developer vessel 111 being a container in a shape of substantial rectangular parallelepiped for accommodating a developer containing a toner and a carrier; a toner supply port 115a for supplying the developer vessel 111 with the toner; a developing roller 114 disposed in the developer vessel 111; first and second developer conveying passages P and Q disposed between a position in the developer vessel 111 where the toner is supplied and the developing roller 114; first and second developer conveying helical members 112 and 113 rotatably disposed in the first and second developer conveying passages P and Q; an agitating blade member 118 rotatably disposed in the first developer conveying passage P to agitate the developer on the first developer conveying helical member 112; a doctor blade 116; and a toner concentration detecting sensor (permeability detecting sensor) 119. The developing device 2 visualizes (develops) an electrostatic latent image formed on the surface of the photoconductor drum 3 by supplying the toner to the surface of the photoconductor drum 3 by use of the developing roller 114.

The developer vessel 111 has its interior partitioned into two chambers by a partitioning plate 117 arranged in parallel to an axial direction of the developing roller 114. One of the two chambers associated with the toner supply port 115a is the first developer conveying passage P, and the other associated with the developing roller 114 is the second developer conveying passage Q.

The first developer conveying passage P and the second developer conveying passage Q communicate each other by a first communicating path (a) and a second communicating path (b) at opposite ends in the axial direction.

Thus, the first and second developer conveying passages P and Q and the first and second communicating paths (a) and (b) form one annular developer conveying passage.

The developer vessel 111 further includes a removable developer vessel cover 115 that forms a top wall of the developer vessel 111.

The developer vessel cover 115 is provided with a toner supply port 115a upstream in a developer conveying direction (an arrow X direction) in the first developer conveying passage P for the purpose of supplying an unused toner. The developer vessel 111 has an opening between a sidewall facing the second developer conveying passage Q and a bottom edge of the developer vessel cover 115. At the opening, the developing roller 114 is rotatably disposed so as to form a prescribed developing nip portion N with the photoconductor drum 3. The developing roller 114 is a magnet roller that is rotated about its axis by not-shown drive means. The developing roller 114 carries the developer in the developer vessel 111 on its surface to supply the toner to the photoconductor drum 3. An application of a developing bias voltage from a not-shown power supply allows the toner to be supplied from the developer on the surface of the developing roller 114 to an electrostatic latent image on the surface of the photoconductor drum 3.

The doctor blade 116 is a rectangular plate-like member extending in parallel to the axial direction of the developing roller 114. A bottom end 116b being its short side is fixed to a bottom edge of the opening of the developer vessel 111, while its top end 116a is away from the surface of the developing roller 114 by a prescribed gap.

The doctor blade 116 may be made of stainless steel, aluminum, synthetic resin or the like, for example.

### <First and Second Developer Conveying Helical Members>

The first developer conveying helical member (hereinafter referred to as the “first helical member”) 112 is structured with a first rotary shaft 112b disposed rotatably in the first developer conveying passage P and in parallel thereto, a helical blade (auger screw) 112a fixed to an outer circumferential surface of the first rotary shaft 112b, and a first gear 112c disposed at one end of the first rotary shaft 112b.

One end of the first rotary shaft 112b penetrates through one sidewall of the developer vessel 111 in terms of the longitudinal direction, to project outside the developer vessel 111, where a first gear 112c is fixed to the one end.

Similarly to the first helical member 112, the second developer conveying helical member (hereinafter referred to as the “second helical member”) 113 is structured with a third rotary shaft 113b disposed rotatably in the second developer conveying passage Q and in parallel thereto, a helical blade (auger screw) 113a fixed to an outer circumferential surface of the third rotary shaft 113b, and a third gear 113c disposed on one end of the third rotary shaft 113b.

One end of the third rotary shaft 113b penetrates through the one sidewall of the developer vessel 111 in terms of the longitudinal direction, to project outside the developer vessel 111, where a third gear 113c is fixed to the one end.

In this case, the helical blade 112a of the first helical member 112 and the helical blade 113a of the second helical member 113 are the same in a helical twist direction.

The first gear 112c of the first helical member 112 meshes with a first drive gear of not-shown drive means (e.g., a motor), and the third gear 113c of the second helical member 113 meshes with a second drive gear of the drive means. As the first drive gear and the second drive gear rotate reversely relative to each other, the first gear 112c and the third gear 113c rotate reversely relative to each other.

Hence, the helical blade 112a of the first helical member 112 and the helical blade 113a of the second helical member 113 rotate reversely relative to each other. Accordingly, as shown in FIG. 3, the developer in the first developer conveying passage P is conveyed in the arrow X direction while being agitated in the rotation direction so as to flow from the first communicating path (a) into the second developer conveying passage Q. The developer in the second developer conveying passage Q is conveyed in an arrow Y direction while being agitated in the rotation direction so as to flow from the second communicating path (b) into the first developer conveying passage P. Thus, the developer circulates through the first developer conveying passage P and the second developer conveying passage Q.

It is to be noted that, the developing device 2 may alternatively be structured having the first and third gears 112c and 113c meshed with each other, and having one of them meshed with one drive gear to rotate, so as to allow the first helical member 112 and the second helical member 113 to rotate reversely relative to each other, because such a structure similarly allows the developer to circulate through the first developer conveying passage P and the second developer conveying passage Q.

Alternatively, the developing device 2 may be structured employing the helical blade 112a of the first helical member 112 and the helical blade 113a of the second helical member 113 each having the helical twist direction reverse to the other's, and having the first and third gears 112c and 113c meshed with an identical drive gear to rotate in the same direction, because such a structure similarly allows the developer to circulate through the first developer conveying passage P and the second developer conveying passage Q.

### <Agitating Blade Member>

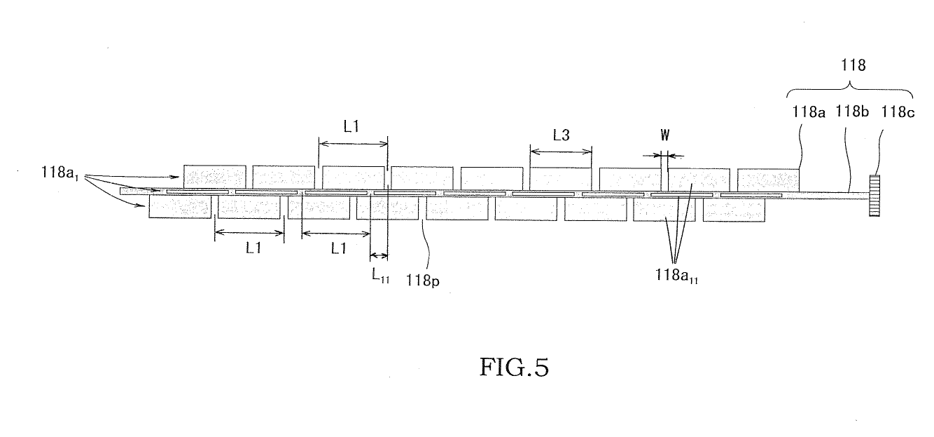

FIG. 5 is a front view showing the agitating blade member in the developing device according to the first embodiment.

As shown in FIGS. 1 to 5, the agitating blade member 118 is structured with a second rotary shaft 118b rotatably disposed right above and near the first rotary shaft 112b in parallel thereto in the first developer conveying passage P, an agitating blade 118a fixed to the second rotary shaft 118b, and a second gear 118c disposed at one end of the second rotary shaft 118b.

The second rotary shaft 118b is rotatably supported at the sidewalls on the opposite sides in terms of the longitudinal direction of the developer vessel 111 so as to be disposed above and near the helical blade 112a of the first helical member 112, having its one end penetrate through the one sidewall of the developer vessel 111 in terms of the longitudinal direction.

The second gear 118c is fixed to the one end of the second rotary shaft 118b projecting outside the developer vessel 111.

The second gear 118c meshes with the first gear 112c of the first helical member 112, and rotates reversely to and in synchronization with the first gear 112c.

More specifically, the first gear 112c and the second gear 118c are each structured by a gear identical to the other's, and rotate at the same rotation speed.

That is, the first gear 112c and the second gear 118c structure a rotary mechanism that rotates the first rotary shaft 112b and the second rotary shaft 118b at the same rotation speed in synchronization with each other.

The agitating blade 118a is structured with a plurality of agitating plate portions 118a₁ radially disposed about the second rotary shaft 118b. In the present embodiment, a central angle formed between two adjacent ones of the agitating plate portions 118a₁ of the agitating blade 118a is 90°. That is, four agitating plate portion sets 118a₁ are provided, each forming the central angle of 90° between adjacent one of the agitating plate portion sets 118a₁.

The agitating plate portions 118a₁ extend in the axial direction of the second rotary shaft 118b, each provided with a plurality of clearances 118p for avoiding any contact with the helical blade 112a when the first and second rotary shafts 112b and 118b synchronously rotate.

In more detail, one agitating plate portion set 118a₁ is made up of a plurality of rectangular plate pieces 118a₁₁ attached along the second rotary shaft 118b having the clearances 118p. An interval L1 of two adjacent ones of the clearances 118p is just as great as a helical interval L2 of the helical blade 112a of the first helical member 112, while a length L3 of the plate piece 118a₁₁ is set shorter than the helical interval L2.

In order to avoid any contact with the helical blade 112a of the first helical member 112 that synchronously rotates, two agitating plate portion sets 118a₁ adjacent to each other by the central angle 90° are disposed on the second rotary shaft 118b such that an interval L₁₁ which is an axial displacement amount of the clearances 118p of the two adjacent ones of the agitating plate portions 118a₁ becomes one-fourth as short as the interval L1.

It goes without saying that a width W of each clearance 118p and the length L3 of each plate piece 118a₁₁ are set so as to avoid any contact with the rotating helical blade 112a of the first helical member 112.

Because the agitating blade member 118 rotates in synchronization with the first helical member 112 at the same rotation speed, the developer on the first rotary shaft 112b can be agitated in the rotation direction of the first rotary shaft 112b while avoiding any contact with the helical blade 112a of the first helical member 112.

It is to be noted that the rotation speed of the agitating blade member 118 may be faster or slower than that of the first helical member 112. In such cases, in order to avoid any contact between the agitating blade member 118 and the first helical member 112, the interval L₁₁ and the width W of each of the clearance 118p of the agitating plate portion sets 118a₁ should be adjusted in accordance with a ratio between the rotation speed of the agitating blade member 118 and that of the first helical member 112.

A toner concentration detecting sensor 119 is mounted at a substantially central portion of the second developer conveying passage Q at a bottom face of the developer vessel 111 right below the second helical member 113, having its sensor face exposed inside the second developer conveying passage Q.

The toner concentration detecting sensor 119 is electrically connected to not-shown toner concentration control means.

The toner concentration control means exerts control in accordance with a toner concentration measurement value detected by the toner concentration detecting sensor 119, so as to rotate a toner discharging member 122 of a toner supplying device 22 (see FIG. 9), whose description will be given later, and to discharge the toner from a toner discharge port 123 to be supplied to the first developer conveying passage P of the developing device 2.

When the toner concentration control means determines that the toner concentration measurement value is lower than a toner concentration set value, a control signal is transmitted to drive means that rotates the toner discharging member 122, whereby the toner discharging member 122 rotates.

The toner concentration detecting sensor 119 may be a general toner concentration detecting sensor, such as a transmitted light detecting sensor, a reflected light detecting sensor, a permeability detecting sensor or the like. Of these, the permeability detecting sensor is preferable.

A not-shown power supply is connected to the permeability detecting sensor (toner concentration detecting sensor 119).

The power supply applies, to the permeability detecting sensor, a drive voltage for driving the permeability detecting sensor and a control voltage as an output of a detection result of the toner concentration to the control means.

The application of the voltages to the permeability detecting sensor by the power supply is controlled by the control means.

The permeability detecting sensor is of a type that receives the control voltage and outputs the detection result of the toner concentration as an output voltage value. Basically, the sensor exhibits an excellent sensitivity about the output center voltage value, and hence a control voltage capable of providing the output voltage around such a value is applied when used.

The permeability detecting sensor of such a type is commercially available. Examples thereof include those marketed under trade names TS-L, TS-A, and TS-K by TDK Corporation.

(Toner Supplying Device)

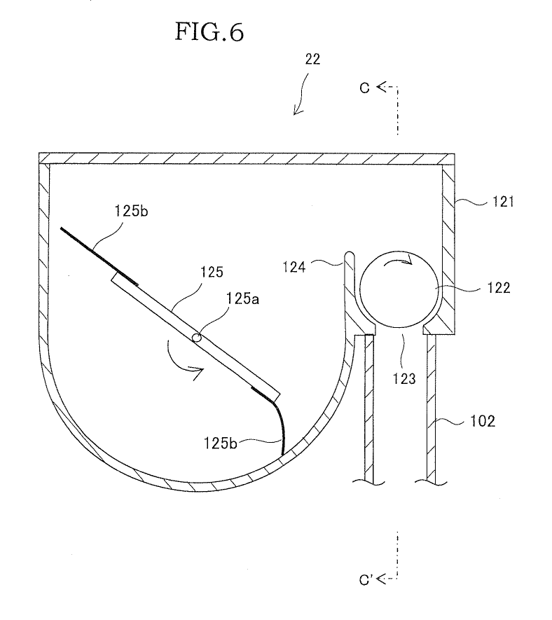

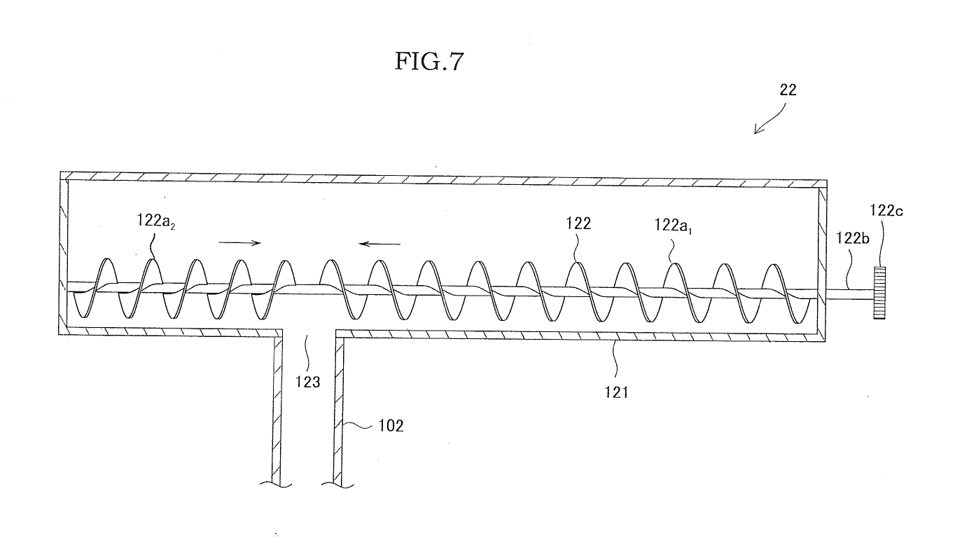

FIG. 6 is a schematic cross-sectional view showing the toner supplying device in the developing device according to the first embodiment. FIG. 7 is a cross-sectional view taken along a line C-C in FIG. 6.

As shown in FIGS. 6 and 7, the toner supplying device 22 includes a toner container 121 having the toner discharge port 123, a toner agitating member 125, and the toner discharging member 122, and accommodates unused toner therein. The toner supplying device 22 is disposed above the developer vessel 111 (see FIG. 1), having its toner discharge port 123 connected to the toner supply port 115a of the developing device 2 by a toner conveying pipe 102.

The toner container 121 is a hollow substantially semicylindrical container. The toner discharge port 123 is disposed beside the circumference of the semicylindrical part.

The toner agitating member 125 is rotatably disposed at a substantially central position of the semicylindrical part of the toner container 121, and the toner discharging member 122 is rotatably disposed at a position above and near the toner discharge port 123.

The toner agitating member 125 is a plate-like member that rotates about a rotary shaft 125a, and has a sheet-like toner draw-up member 125b made of an elastic resin (e.g., polyethylene terephthalate) at each opposite tip away from the rotary shaft 125a. In this case, the rotary shaft 125a is rotatably supported at opposite sidewalls of the toner container 121 in terms of the longitudinal direction. One end of the rotary shaft 125a penetrates through the sidewall. A gear meshing with a drive gear of not-shown drive means is fixed to the one end.

As the toner draw-up member 125b of the toner agitating member 125 rotates from the bottom toward the top relative to the toner discharge port 123, the toner accommodated in the toner container 121 is drawn up while being agitated, and conveyed to the toner discharging member 122.

In this case, the elasticity of the toner draw-up member 125b allows the toner draw-up member 125b to slidably rotate as being deformed along the interior wall of the toner container 121, to thereby supply the toner toward the toner discharging member 122.

It is to be noted that a toner discharging member partition wall 124 is provided between the toner discharging member 122 and the toner agitating member 125, such that the toner drawn up by the toner agitating member 125 can be retained by an appropriate amount around the toner discharging member 122.

The toner discharging member 122 is structured with a rotary shaft 122b having its opposite ends rotatably supported at opposite sidewalls of the toner container 121 in terms of the longitudinal direction, first and second helical blades 122a₁ and 122a₂ fixed to an outer circumferential surface of the rotary shaft 122b, and a gear 122c fixed to one end of the rotary shaft 122b penetrating through the sidewall of the toner container 121.

The gear 122c meshes with a drive gear of not-shown drive means.

The helical twist direction of the first helical blade 122a₁ is reverse relative to that of the second helical blade 122a₂. The toner discharge port 123 is arranged between the first helical blade 122a₁ and the second helical blade 122a₂.

A rotation of the toner discharging member 122 allows the toner supplied around the toner discharging member 122 to be conveyed by the first helical blade 122a₁ and the second helical blade 122a₂ from axial opposite ends of the toner discharging member 122 toward the toner discharge port 123, and to be supplied from the toner discharge port 123 into the developer vessel 111 via the toner conveying pipe 102.

<Operation of Developing Device>

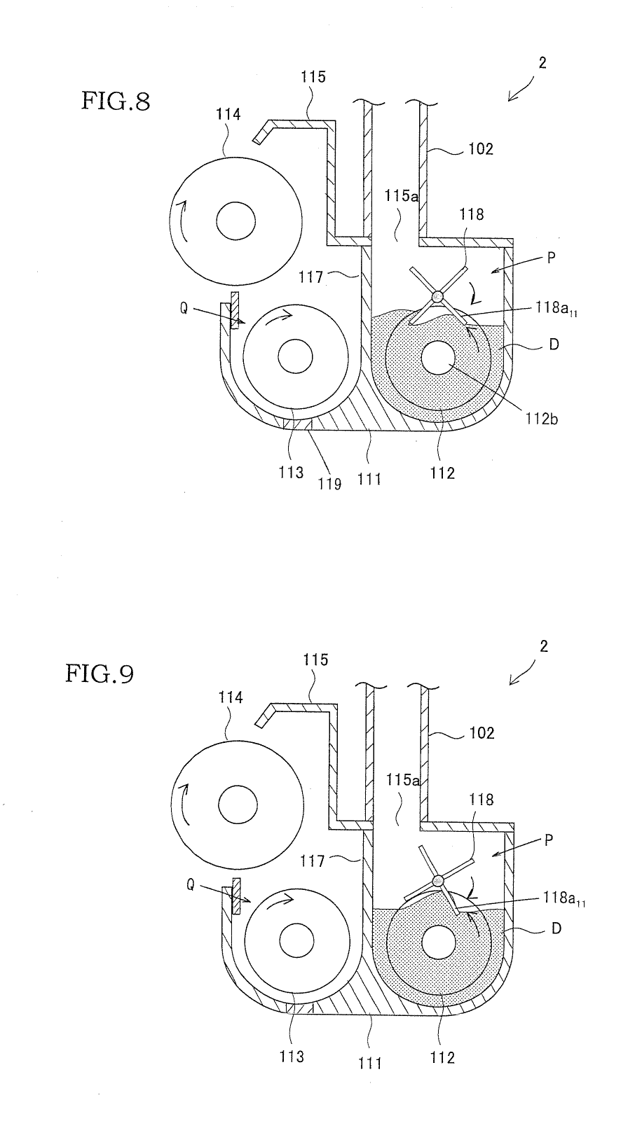

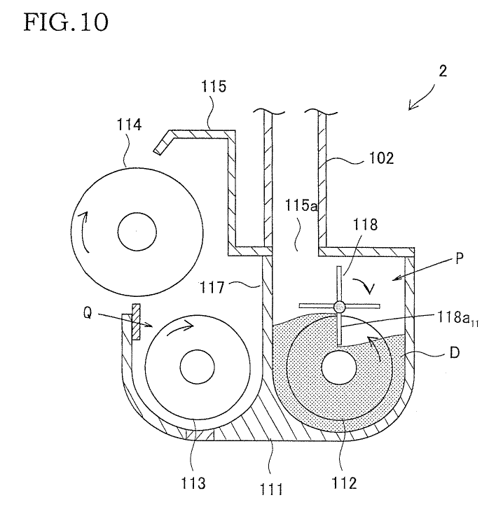

FIGS. 8 to 10 are cross-sectional views each describing an agitation state of the developer caused by the agitating blade member of the developing device according to the first embodiment is in operation. In FIGS. 8 to 10, the developer D in the second developer conveying passage Q of the developing device 2 is not illustrated.

In a developing step with the image forming apparatus, as shown in FIG. 8, the developing roller 114, the first and second helical members 112 and 113, and the agitating blade member 118 of the developing device 2 rotate in directions indicated by arrows, respectively.

In this case, the developer D in the first developer conveying passage P is conveyed in the arrow X direction (see FIGS. 3 and 4) while being agitated by the first helical member 112 in its rotational circumferential direction, to be supplied into the second developer conveying passage Q. By the agitating blade member 118, the developer D on the first rotary shaft 112b of the first helical member 112 is agitated in the circumferential direction of the first rotary shaft 112b in order of FIGS. 8, 9 and 10.

On the other hand, the developer in the second developer conveying passage Q is conveyed in the arrow Y direction (see FIG. 3) while being agitated by the second helical member 113 in its rotational circumferential direction, and partially supplied to the developing roller 114.

The developer supplied to the developing roller 114 is sent to the photoconductor drum 3 (see FIG. 2) by the doctor blade 116 in a form of a uniform developer layer having a prescribed thickness on the outer circumferential surface of the developing roller 114. From the developer layer, the toner is partially supplied to the photoconductor drum 3. Thereafter, the developer whose toner concentration is lowered on the developing roller 114 is blended with the developer in the second developer conveying passage Q.

Accordingly, the toner concentration of the developer in the second developer conveying passage Q gradually becomes low.

Because the toner concentration of the developer in the second developer conveying passage Q is detected by the toner concentration detecting sensor 119, when the toner concentration becomes smaller than a prescribed value, the unused toner is supplied from the toner supplying device 22 onto the developer (existing developer) D in the first developer conveying passage P.

Because a specific gravity of the toner is smaller than a specific gravity of the carrier in the developer, the toner is not easily blended into the existing developer D with the rotation of the first helical member 112 solely. However, as described in the foregoing, thanks to the rotation of the agitating blade member 118 above the first helical member 112, the supplied toner on the first rotary shaft 112b is blended into the existing developer D.

In this case, as shown in order of FIGS. 8, 9 and 10, because the plate pieces 118a₁₁ on the bottom side of the agitating blade member 118 move in the rotation direction of the first helical member 112 to push the supplied toner and the existing developer D in one direction, a great height difference is generated between the top layer of the developer on one side and that on the other side with respect to the first rotary shaft 112b. This makes it easier for the supplied toner whose specific gravity is smaller than that of the carrier to be blended into the existing developer D.

As has been described in the foregoing, because the developer D on the first rotary shaft 112b is agitated in the rotational circumferential direction every time the agitating blade member 118 rotates by 90°, the supplied toner is uniformly dispersed in the developer D and sufficiently electrified, while the developer D is free of degradation due to the stress as being pressurized near the bottom of the developer vessel 111.

Then, during the course of circulation of the developer D through the first developer conveying passage P and the second developer conveying passage Q, the toner concentration distribution of the developer D becomes uniform, and the toner concentration recovers to the prescribed value.

### (Intermediate Transfer Belt Unit and Intermediate Transfer Belt Cleaner Unit)

As shown in FIG. 1, the intermediate transfer belt unit 8 disposed above the photoconductor drums 3 includes an intermediate transfer belt 7, intermediate transfer rollers 6a, 6b, 6C, and 6d (hereinafter, the description will collectively be given employing a unified reference character “6”) for suspending the intermediate transfer belt 7 in a tense state to rotate the same in an arrow B direction in FIG. 1, a drive roller 71, a driven roller 72 and a belt tensioning mechanism (not-shown), and a transfer roller 11 disposed beside and in proximity to the drive roller 71. It is to be noted that the intermediate transfer rollers 6 are each rotatably supported by a roller mounting portion of the belt tensioning mechanism.

Further, the intermediate transfer belt cleaner unit 9 is disposed next to the driven roller 72 of the intermediate transfer belt unit 8.

The drive roller 71 and the driven roller 72 are disposed externally to the outmost photoconductor drums 3, respectively, out of the four photoconductor drums 3, so that the intermediate transfer belt 7 is brought into contact with the photoconductor drums 3.

The intermediate transfer belt 7 is formed in an endless manner using a film having a thickness of about 100 to 150 μm, for example. The toner images of different color components formed on respective photoconductor drums 3 are successively transferred one over another on the external face of the intermediate transfer belt 7, to form a full-color toner image (multi-color toner image).

A transfer operation of the toner image from the photoconductor drums 3 to the intermediate transfer belt 7 is carried out by the intermediate transfer rollers 6 which are in contact with an internal face of the intermediate transfer belt 7.

Each intermediate transfer roller 6 is made up of a metal shaft (e.g., made of stainless steel) having a diameter of, e.g., 8 to 10 mm, and a conductive elastic material layer coating the outer circumferential surface of the metal shaft.

Examples of the conductive elastic material layer include ethylene propylene diene terpolymer (EPDM), foamed urethane or the like that contains a conductive material such as carbon black.

A high-voltage transfer bias (a high voltage whose polarity is opposite (+) to a polarity (−) of the electrostatic charge on the toner) is applied to the metal shaft of each of the intermediate transfer rollers 6 for transferring the toner images, whereby the intermediate transfer rollers 6 can uniformly apply a high voltage to the intermediate transfer belt 7.

While intermediate transfer rollers 6 are used as transfer electrodes in the present embodiment, brushes or the like can be used instead.

The toner image overlaid on the external surface of the intermediate transfer belt 7 shifts to a position of the transfer roller 11 (transfer portion) by the rotation of the intermediate transfer belt 7.

On the other hand, a recording medium is also conveyed through the sheet conveying path S to the transfer portion, where the recording medium is pressed against the intermediate transfer belt 7 by the transfer roller 11. Thus, the toner image on the intermediate transfer belt 7 is transferred onto the recording medium.

In this case, the intermediate transfer belt 7 and the transfer roller 11 are pressed against each other at a prescribed nip, while a high voltage is applied to the transfer roller 11 for transferring the toner image onto the recording medium. In this case, a polarity of the high voltage is opposite (+) to the polarity (−) of the electrostatic charge on the toner.

Further, in order to constantly obtain the nip between the intermediate transfer belt 7 and the transfer roller 11, one of the transfer roller 11 and the drive roller 71 is formed of a hard material such as metal, and the other is formed of a soft material such as rubber, foamed resin or the like.

The toner having not been transferred from the intermediate transfer belt 7 to the recording medium and remaining on the intermediate transfer belt 7 may cause undesired blend of toners of different colors when overlaying a new toner image on the intermediate transfer belt 7, and hence the remaining toner is removed and collected by the intermediate transfer belt cleaner unit 9.

The intermediate transfer belt cleaner unit 9 includes a cleaning blade in contact with the intermediate transfer belt 7 to remove the remaining toner, and a toner collector that collects the removed toner. It is noted that a portion in the intermediate transfer belt 7 which is brought into contact with the cleaning blade is supported by the driven roller 72.

### (Sheet Conveying Path and Peripheral Member Thereof)

As shown in FIG. 1, the sheet conveying path S extends from the sheet feeding tray 10 and the manual sheet feeding tray 20, passing through the fusing device 12 whose description will be given later, to reach the sheet exit tray 15. Along the sheet conveying path S, pickup rollers 16a and 16b, feed rollers 25a to 25h (hereinafter, the description will collectively be given employing a unified reference character “25”), a registration roller 14, the transfer roller 11, the fusing device 12 and the like are disposed.

The feed rollers 25 are small rollers for facilitating and assisting sheet conveyance, and paired along the sheet conveying path S.

The pickup roller 16a is disposed at an end portion of the sheet feeding tray 10, to pick up sheet-like recording media (recording sheets) one by one from the feed tray 10 and supplies it to the sheet conveying path S.

The pickup roller 16b is disposed near the manual sheet feeding tray 20, to pick up the recording media one by one from the manual sheet feeding tray 20 and supplies it to the sheet conveying path S.

The registration roller 14 temporarily holds the recording medium conveyed on the sheet conveying path S, and delivers the recording medium to the transfer portion at a timing intended to align a tip of the toner image on the intermediate transfer belt 7 with a tip of the recording medium.

### [Fusing Device Housing]

As shown in FIG. 1, the fusing device 12 accommodated in the fusing device housing 100B includes a heat roller 81 and a pressure roller 82 that rotate in directions opposite to each other while clamping the recording medium carrying the transferred toner image thereon, a feed roller 25b, and a sheet exit roller 25c.

The heat roller 81 is controlled by a not-shown controller such that it reaches a prescribed fusing temperature. The controller controls the temperature of the heat roller 81 based on a detection signal received from a not-shown temperature detector.

The heat roller 81 having reached the fusing temperature and the pressure roller 82 press against the recording medium to melt the toner, whereby the toner image is fused on the recording medium.

The recording medium having the toner image fused thereon is conveyed by the feed roller 25b and the sheet exit roller 25c to take a turn-over sheet exit route of the sheet conveying path S, and ejected on the sheet exit tray 15 as being turned over (i.e., the toner image facing down).

### <Second Embodiment>

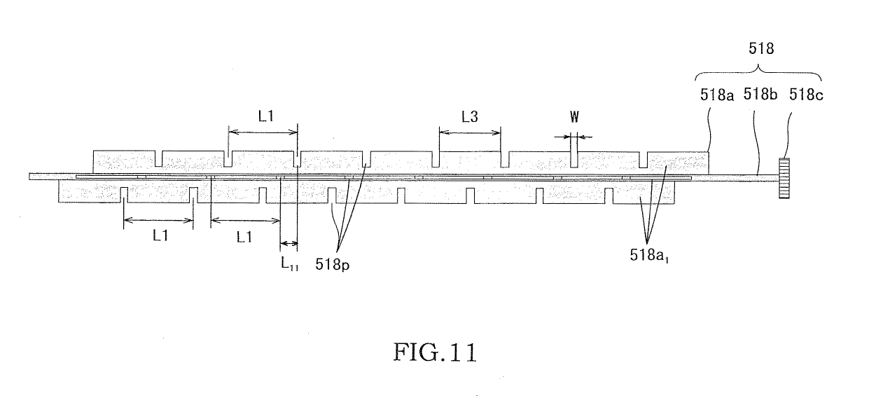

FIG. 11 is a front view showing an agitating blade member of a developing device according to a second embodiment of the present invention.

Because the second embodiment is the same as the first embodiment except for an agitating blade member 518, a description will be given hereinafter mainly of the difference from the first embodiment with reference to FIG. 11 and FIGS. 2 to 5.

As shown in FIG. 11, the agitating blade member 518 is structured with a first rotary shaft 518b and a gear 518c which are similar to the first rotary shaft 118b and the gear 118c of the agitating blade member 118 (see FIG. 5) according to the first embodiment, and an agitating blade 518a which differs from the agitating blade 118a of the agitating blade member 118 according to the first embodiment.

The agitating blade 518a is made up of four agitating plate portions 518a₁ fixed to the outer circumferential surface of the first rotary shaft 518b so as to form a central angle of 90° between adjacent ones of the agitating plate portions 518a₁.

The agitating plate portions 518a₁ each extend in the axial direction of the second rotary shaft 118b, and provided with a plurality of notches 518p for avoiding any contact with the helical blade 112a when the first rotary shaft 112b of the first helical member 112 (see FIG. 2) and the second rotary shaft 518b synchronously rotate.

In one agitating plate portion 518a₁, an interval L1 between two adjacent ones of the notches 518p is just as great as the helical interval L2 of the helical blade 112a of the first helical member 112, while a length L3 of a rectangular portion between the two adjacent notches 518p (which corresponds to the plate piece 518a₁₁ according to the first embodiment) is set shorter than the helical interval L2.

In order to avoid any contact with the helical blade 112a of the first helical member 112 that synchronously rotate, two adjacent ones of the agitating plate portions 518a₁ adjacent to each other by the central angle of 90° are disposed on the second rotary shaft 518b such that an interval L₁₁ which is an axial displacement amount of the notches 518p becomes one-fourth as short as the interval L1.

It goes without saying that a width W of each notch 518p and the length L3 are set so as to avoid any contact with the rotating helical blade 112a of the first helical member 112.

As in the first embodiment, in the second embodiment also, because the agitating blade member 518 rotates in synchronization with the first helical member 112 at the same rotation speed, the developer on the first rotary shaft 112b can be agitated in the rotation direction of the first rotary shaft 112b while avoiding any contact with the helical blade 112a of the first helical member 112.

It is to be noted that the rotation speed of the agitating blade member 518 may be faster or slower than that of the first helical member 112. In such cases, in order to avoid any contact between the agitating blade member 518 and the first helical member 112, the interval L₁₁ and the width W of the notch 518p of each agitating plate portion 518a₁ should be adjusted in accordance with a ratio between the rotation speed of the agitating blade member 518 and that of the first helical member 112.

What is claimed is:

1. A developing device to be installed in an electrophotographic image forming apparatus including a photoconductor drum that is to have an electrostatic latent image formed on a surface thereof, the developing device comprising:
a developer vessel that accommodates a developer containing a toner and a carrier;
a toner supply port for supplying the toner into the developer vessel;
a developing roller that is disposed in the developer vessel and that rotates while carrying the developer to supply the toner onto the surface of the photoconductor drum having the electrostatic latent image formed thereon;
a developer conveying passage that is disposed between a position in the developer vessel where the toner is supplied and the developing roller;
a developer conveying helical member that is rotatably disposed in the developer conveying passage to convey the developer in the developer conveying passage to the developing roller while agitating the developer; and
an agitating blade member that is rotatably disposed above, near and along the developer conveying helical member in the developer conveying passage to agitate the developer on the developer conveying helical member.

2. The developing device according to claim 1, wherein the developer conveying passage includes:
a first developer conveying passage associated with the toner supply port and a second developer conveying passage associated with the developing roller, the first developer conveying passage and the second developer conveying passage being defined by a partitioning plate extending in parallel to an axial direction of the developing roller; and
a first communicating path and a second communicating path that establish a communication between the first developer conveying passage and the second developer conveying passage at opposite sides in the axial direction,
the developer conveying helical member includes a first developer conveying helical member disposed in the first developer conveying passage and a second developer conveying helical member disposed in the second developer conveying passage,
the agitating blade member is disposed above and near the first developer conveying helical member in the first developer conveying passage, and
the first developer conveying helical member and the second developer conveying helical member convey the developer in directions opposite to each other, such that the developer circulates through the first developer conveying passage and the second developer conveying passage.

3. The developing device according to claim 2, wherein
the first developer conveying helical member includes a first rotary shaft rotatably disposed in the first developer conveying passage and a helical blade fixed to the first rotary shaft, and
the agitating blade member includes a second rotary shaft rotatably disposed above, near and in parallel to the first rotary shaft in the first developer conveying passage, and an agitating blade fixed to the second rotary shaft.

4. The developing device according to claim 3, wherein
the second rotary shaft is disposed right above the first rotary shaft.

5. The developing device according to claim 3, further comprising:
a rotary mechanism that synchronously rotates the first rotary shaft and the second rotary shaft, wherein
the agitating blade is made up of a plurality of agitating plate portions radially disposed about the second rotary shaft, and
the agitating plate portions are formed so as to extend in an axial direction of the second rotary shaft and have a plurality of clearances or notches for avoiding any contact with the helical blade when the first and second rotary shafts are synchronously rotated.

6. The developing device according to claim 5, wherein
the rotary mechanism rotates the first rotary shaft and the second rotary shaft at an identical rotation speed, and
an interval of the plurality of clearances or notches of the agitating plate portions is identical to a helical interval of the helical blade.

7. The developing device according to claim 5, wherein
a central angle formed between two circumferentially adjacent ones of the agitating plate portions of the agitating blade is 90°.

8. An image forming apparatus, comprising:
a photoconductor drum that is to have an electrostatic latent image formed on a surface thereof;
a charging device that electrifies the surface of the photoconductor drum;
an exposure device that forms the electrostatic latent image on the surface of the photoconductor drum;
the developing device according to claim 1 which supplies a toner to the electrostatic latent image on the surface of the photoconductor drum to form a toner image;
a toner supplying device that supplies the toner to the developing device;
a transferring device that transfers the toner image on the surface of the photoconductor drum to a recording medium; and
a fusing device that fuses the toner image on the recording medium.
